(19) United States
(12) Patent Application Publication
(10) Pub. No.: US 2026/0285245 A1
(43) Pub. Date: Sep. 24, 2026

(54) TWISTING WIRE HARNESS ASSEMBLY FOR STEER-BY-WIRE COLUMN

(71) Applicant: Steering Solutions IP Holding Corporation, Saginaw, MI (US)

(72) Inventors: Benjamin Schulte, Midland, MI (US); Jesse Holden, Wellston, MI (US); Aidan Watson, Essexville, MI (US)

(21) Appl. No.: 19/088,365

(22) Filed: Mar. 24, 2025

(51) Int. Cl. B60R 16/02; B62D 1/04; B62D 1/16

(52) U.S. Cl. CPC B60R 16/0215; B62D 1/04; B62D 1/16

(57) ABSTRACT

A vehicle steer-by-wire system includes a column jacket. The steer-by-wire system also includes a hand wheel actuator operatively coupled to an end of the column jacket, the hand wheel actuator comprising a motor and a spindle, the spindle operatively coupleable to a steering wheel hub. The steer-by-wire system further includes a rotatable wire harness assembly. The wire harness assembly includes a guide tube having at least a portion thereof disposed within an interior cavity defined by the spindle. The wire harness assembly also includes an electrical connection conduit having at least a portion thereof disposed within an interior of the guide tube.

### FIELD OF THE INVENTION

The embodiments described herein relate to vehicle steering systems and, more particularly, to a twisting wire harness assembly for a steer-by-wire system.

### BACKGROUND

Vehicles include various types of steering system schemes to allow an operator to provide a steering input that results in manipulation of vehicle road wheels. Certain electrical connections are often made between the steering wheel and other components to provide various functions associated with the steering wheel. A wire harness is typically utilized to assist with the electrical wire routing. A challenge exists in this region since the steering wheel rotates during use. Prior wire harnesses used in rotating applications, such as with steering wheels, include slip rings and clock springs. Slip rings use sliding electrical contacts to transmit power and signals, but are more prone to producing noise and are limited to straight coaxial pathways. Clock springs use a flexible coiled ribbon cable to transmit power and signals. Slip rings are more durable and less noisy than a slip ring, but are limited to close proximity rotating interfaces.

### SUMMARY

According to one aspect of the disclosure, a vehicle steer-by-wire system includes a column jacket. The steer-by-wire system also includes a hand wheel actuator operatively coupled to an end of the column jacket, the hand wheel actuator comprising a motor and a spindle, the spindle operatively coupleable to a steering wheel hub. The steer-by-wire system further includes a rotatable wire harness assembly. The wire harness assembly includes a guide tube having at least a portion thereof disposed within an interior cavity defined by the spindle. The wire harness assembly also includes an electrical connection conduit having at least a portion thereof disposed within an interior of the guide tube.

According to another aspect of the disclosure, a vehicle steer-by-wire system includes a column jacket. The steer-by-wire system also includes a hand wheel actuator operatively coupled to an end of the column jacket, the hand wheel actuator comprising a motor and a spindle, the spindle operatively coupleable to a steering wheel hub. The steer-by-wire system further includes a rotatable wire harness assembly. The wire harness assembly includes a guide tube having at least a portion thereof disposed within an interior cavity defined by the spindle, wherein the guide tube comprises a straight segment and a curved segment, wherein the straight segment and the curved segment are both tubular to define a guide tube interior. The wire harness assembly also includes a flat ribbon cable having at least a portion thereof disposed within an interior of the guide tube. The wire harness assembly further includes a first bushing. The wire harness assembly yet further includes a second bushing, wherein the guide tube extends through the first bushing and the second bushing.

According to another aspect of the disclosure, a vehicle steer-by-wire system includes a column jacket. The steer-by-wire system also includes a hand wheel actuator operatively coupled to an end of the column jacket, the hand wheel actuator comprising a motor and a spindle, the spindle operatively coupleable to a steering wheel hub. The steer-by-wire assembly further includes a rotatable wire harness assembly. The wire harness assembly includes a guide tube having at least a portion thereof disposed within an interior cavity defined by the spindle, comprises a straight segment and a curved segment, wherein the straight segment and is tubular to define a guide tube interior, wherein the curved segment is a curved flange segment having a flat edge. The wire harness assembly also includes a flat ribbon cable having at least a portion thereof disposed within an interior of the guide tube, wherein the flat ribbon cable has a first portion disposed in contact with the flat edge of the curved flange segment, wherein the flat ribbon cable enters a first open end of the straight segment of the guide tube and extends along the guide tube interior with a second portion of the flat ribbon cable. The wire harness assembly further includes a first bushing. The wire harness assembly yet further includes a second bushing, wherein the guide tube extends through the first bushing and the second bushing.

According to another aspect of the disclosure, a vehicle steer-by-wire system includes a column jacket. The vehicle steer-by-wire system also includes a hand wheel actuator operatively coupled to an end of the column jacket, the hand wheel actuator comprising a motor and a spindle, the spindle operatively coupleable to a steering wheel hub. The vehicle steer-by-wire system further includes a rotatable wire harness assembly. The wire harness assembly includes a guide tube having at least a portion thereof disposed within an interior cavity defined by the spindle, wherein the guide tube comprises a straight segment and a curved segment, wherein the straight segment and the curved segment are both tubular to define a guide tube interior. The wire harness assembly also includes a twisted bundle of wires extending through the guide tube interior. The wire harness assembly further includes a first bushing. The wire harness assembly further includes a second bushing, wherein the guide tube extends through the first bushing and the second bushing.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically illustrates a vehicle steering system.

FIG. 2 is a perspective, cross-sectional view of a hand wheel actuator for the vehicle steering system, illustrating a twisting wire harness assembly.

FIG. 3 is a perspective view of a guide tube of the twisting wire harness assembly.

FIG. 4 is a perspective, cross-sectional view of the twisting wire harness assembly according to another aspect of the disclosure.

FIG. 5 is a perspective, cross-sectional view of the hand wheel actuator for the vehicle steering system, illustrating a twisting wire harness assembly according to another aspect of the disclosure.

FIG. 6 is a perspective view of a bushing of the twisting wire harness assembly.

FIG. 7 is an elevational, end view of a portion of the twisting wire harness assembly.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

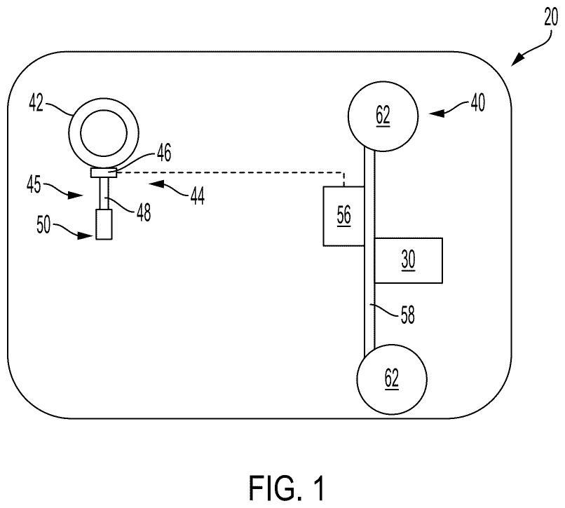

Referring initially to FIG. 1, a vehicle 20 is generally illustrated according to the principles of the present disclosure. The vehicle 20 may be any vehicle, such as a car, a truck, a sport utility vehicle, a mini-van, a crossover, any other passenger vehicle, any commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an internal combustion system, an electric system, or combinations thereof.

The vehicle 20 includes a steering system 40. The steering system 40 may be configured as a driver interface steering system, an autonomous driving system, or a system that allows for both driver interface and autonomous steering. The steering system includes a steering input device 42, such as a steering wheel, wherein a driver may manually provide a steering input by turning the steering wheel. A steering column assembly 44 includes a steering column 45 that extends along an axis. A hand wheel actuator (“HWA”) 46 (which may also be referred to as an “emulator”) is provided in the steer-by-wire system and is used to provide feedback and assistance to the steering input device 42 and to receive manual driver inputs for steering control.

The steering column 45 includes one or more portions, for example, an upper jacket 48 and a lower jacket 50. While two jackets are illustrated and described, it is to be appreciated that a single jacket or three or more jackets may be provided in some embodiments. Regardless of the number of jackets, the jackets may be axially and or height adjustable to be moveable over a range of positions to meet user preferences for positioning of the steering input device 42.

A road wheel actuator (“RWA”) 56 is in operative communication with the hand wheel actuator 46. The road wheel actuator 56 actuates lateral maneuvers of the vehicle in response to inputs received from the hand wheel actuator 46. Each of the hand wheel actuator 46 and the road wheel actuator 56 may include a respective processor and controller or a single processor may be in communication with a respective controller of each of the hand wheel actuator 46 and the road wheel actuator 56.

The road wheel actuator 56 is part of a system which includes an output that drives a rack, ball screw or any other cross-car oriented component that is operatively coupled to the road wheels 62.

Historically, a continuous mechanical connection spanning multiple components was utilized to connect the steering wheel 42 to the vehicle road wheels 62. However, steer-by-wire systems have eliminated the need for an uninterrupted mechanical connection between the steering wheel 42 and the vehicle road wheels 62. For example, a steering shaft which couples to the steering wheel and one or more additional shafts (e.g., intermediate shaft) is no longer needed in some systems. Advancements such as those outlined above present new opportunities and challenges in steer-by-wire systems. For example, certain components may be moved away from traditional locations to new locations within the system.

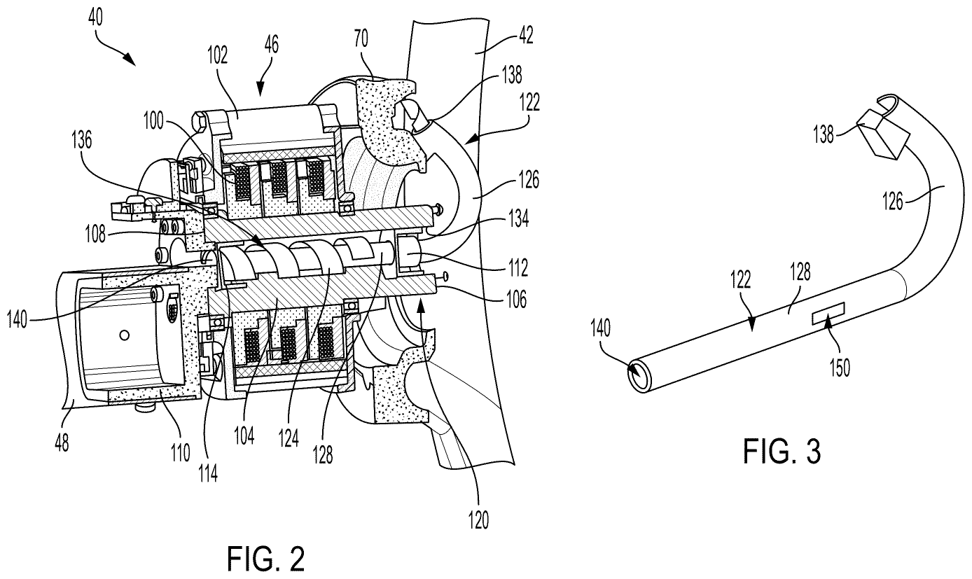

Referring now to FIG. 2, a portion of the steering system 40 located adjacent to the steering wheel 42 is illustrated. A rearward portion of the steering wheel 42 is shown, with the hand wheel actuator 46 operatively coupled to the rear side (i.e., side of wheel away from operator) of the steering wheel 42. In the illustrated embodiment, the hand wheel actuator 46 is operatively coupled to a rearward side of a steering wheel hub 70. The hand wheel actuator 46 includes a motor 100 disposed within a motor housing 102. A spindle 104 is disposed within the motor 100 and shares a coaxial axis of rotation with the motor 100. The steering wheel 42 is mounted to a first end 106 of the spindle 104 and rotates therewith. A second end 108 of the spindle 104 is operatively coupled to an adapter 110. The adapter is operatively coupled to the upper jacket 48. Stability of the spindle 104 during rotation is maintained by a first bushing 112 located proximate the first end 106 of the spindle 104 and a second bushing 114 located proximate the second end 108 of the spindle 104.

Electrical connections between the steering wheel 42 and other vehicle components are made to provide various functions associated with the steering wheel 42. The embodiments disclosed herein provide a twisting wire harness assembly 120 that maintains the wired electrical connections over a large range of rotation of the steering wheel 42.

The twisting wire harness assembly 120 includes the above-described spindle 104 and the bushings 112, 114, as well as a guide tube 122 and a flat ribbon cable 124. The guide tube 122 (also shown in FIG. 3) includes a curved segment 126 and a substantially straight portion 128. The guide tube 122 has a substantially cylindrical cross-section in some embodiments, as illustrated. While the curved segment 126 may be continuously curving along an entire length thereof in some embodiments, the curved segment 126 may include some non-curved portions.

The spindle 104 is a hollow component, with the first open end 106 located adjacent to the steering wheel hub 70. The second end 108 of the spindle 104 may or may not be open. An inner wall 134 of the spindle 104 defines a cavity 136. The straight portion 128 of the guide tube 122 extends within the cavity 136 in a longitudinal direction of the spindle 104. The guide tube 122 also extends through respective holes defined by the first bushing 112 and the second bushing 114 to stably hold the guide tube 122 in a fixed position.

The guide tube 122 extends from a first end 138 to a second end 140. The first end 138 is at a terminal end of the curved segment 126 of the guide tube 122. The second end 140 is at a terminal end of the straight segment 128 of the guide tube 122. The first end 138 is located within the steering wheel hub 70. The flat ribbon cable 124 has a portion of its length that is disposed within a hollow portion of the guide tube 122. In particular, the flat ribbon cable 124 extends through the curved portion 126 of the guide tube 122 and protrudes out of the first end 138 of the guide tube 122 for connection with electrical components disposed in or on the steering wheel hub 70. The guide tube 122 includes a ribbon cable exit slot 150. In the illustrated embodiment, the ribbon cable exit slot 150 is located along the straight segment 128 of the guide tube 122. The ribbon cable exit slot 150 exits the interior of the guide tube 122 through the ribbon cable exit slot 150 and wraps around an outer diameter of the remainder of the straight segment 128 of the guide tube in a direction toward the second end 140 of the guide tube 122. The flat ribbon cable 124 is strain relieved at a location proximate the second bushing 114.

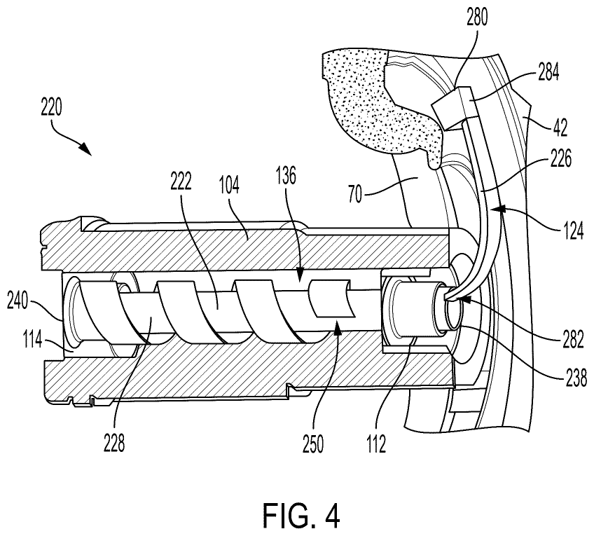

Referring now to FIG. 4, the twisting wire harness assembly is shown according to another aspect of the disclosure and is referenced generally with numeral 220. As with the embodiments of FIGS. 2 and 3, the assembly includes the spindle 104 and bushings 112, 114. A guide tube 222 of the twisting wire harness assembly 220 includes a substantially straight tube portion 228 and a substantially curved flange portion 226. The straight tube portion 228 has a substantially cylindrical cross-section in some embodiments, as illustrated in FIG. 4. While the curved flange portion 226 may be continuously curving along an entire length thereof in some embodiments, the curved flange portion 226 may include one or more straight portions.

The straight portion 228 of the guide tube 222 extends within the cavity 136 in a longitudinal direction of the spindle 104. The straight portion 228 also extends through respective holes defined by the first bushing 112 and the second bushing 114 to stably hold the guide tube 222 in a fixed position.

The straight portion 228 of the guide tube 222 extends from a first end 238 to a second end 240. The first end 238 is at a terminal end of the straight segment 228 and is located proximate the first bushing 112. The second end 240 is at an opposite terminal end of the straight segment 228 and is located proximate the second bushing 114. The curved flange portion 226 of the guide tube 222 also includes a first end 280 and a second end 282. The first end 280 is at a terminal end of the curved flange portion 226. The second end 282 is at an opposite terminal end of the curved flange portion 226. The first end 280 is located within the steering wheel hub 70 and is operatively coupled to the steering wheel 42.

The flat ribbon cable 124 has a portion of its length that is positioned along a flat edge 284 of the curved flange portion 226. In particular, the flat ribbon cable 124 extends along the flat edge 284 of the curved flange portion 226 and extends to be in close proximity to the first end 280 of the curved flange portion 226 for connection with electrical components disposed in or on the steering wheel hub 70. The flat ribbon cable 124 enters an interior portion of the straight segment 228 of the guide tube 222 from the curved flange portion 226. The guide tube 222 includes a ribbon cable exit slot 250 defined by the straight segment 228. The ribbon cable exit slot 250 exits the interior of the straight segment 228 through the ribbon cable exit slot 250 and wraps around an outer diameter of the remainder of the straight segment 228 of the guide tube 222 in a direction toward the second end 240 of the straight segment 228. The flat ribbon cable 124 is strain relieved at a location proximate the second bushing 114.

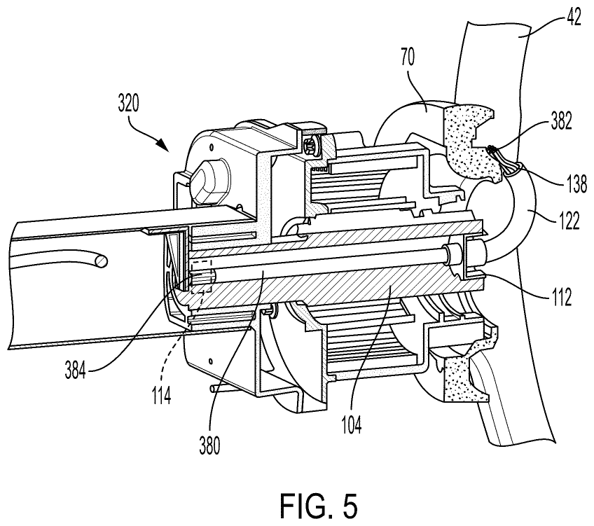

Referring now to FIG. 5, the twisting wire harness assembly is shown according to another aspect of the disclosure and is referenced generally with numeral 320. As with the embodiments of FIGS. 2 and 3, the assembly includes the spindle 104, bushings 112, 114 and the guide tube 122. In the illustrated embodiment, the guide tube 122 has a bundle of twisted wires 380 disposed within, and extending throughout, an interior of the guide tube 122. A first end 382 of the twisted wires 380 protrudes from the first end 138 of the guide tube 122 and a second end 384 of the twisted wires 380 protrudes from the second end 140 of the guide tube 122.

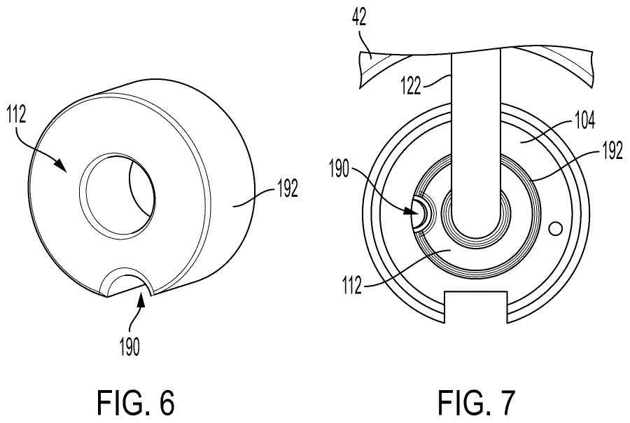

Referring now to FIGS. 6 and 7, another aspect of the disclosure which may be incorporated in any of the embodiments disclosed herein is shown. The first bushing 112 is shown with a recessed portion 190 defined along an outer diameter 192 of the first bushing 112. The recessed portion 190 provides space for routing of air bag wires to pass through to the steering wheel hub 70.

The embodiments disclosed herein allow for substantial rotation of the steering wheel 42, and associated components, without threatening the electrical connections required for operation of various features. In some embodiments, rotation of at least 170 degrees in both a clockwise and counterclockwise direction are possible, while still allowing transmission of steering wheel control signals and power transmission for features, such as heated steering wheels, for example. The embodiments disclosed herein also allow for a reduction in materials and cost, when compared to wire harness designs which rely on clock springs or slip rings.

The flat ribbon cable 124 and the bundle of twisted wires 380 may be generally referred to herein as an “electrical connection conduit”.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A vehicle steer-by-wire system comprising:
a column jacket;
a hand wheel actuator operatively coupled to an end of the column jacket, the hand wheel actuator comprising a motor and a spindle, the spindle operatively coupleable to a steering wheel hub; and
a rotatable wire harness assembly comprising:
a guide tube having at least a portion thereof disposed within an interior cavity defined by the spindle; and
an electrical connection conduit having at least a portion thereof disposed within an interior of the guide tube.

2. The vehicle steer-by-wire system of claim 1, wherein the electrical connection conduit is a flat ribbon cable.

3. The vehicle steer-by-wire system of claim 2, wherein the guide tube comprises a straight segment and a curved segment, wherein the straight segment and the curved segment are both tubular to define a guide tube interior.

4. The vehicle steer-by-wire system of claim 3, wherein the flat ribbon cable is positioned within the guide tube interior through the curved segment and is wrapped along an outer diameter of the straight segment.

5. The vehicle steer-by-wire system of claim 4, wherein the straight segment defines a ribbon cable exit slot, wherein the flat ribbon cable extends through the ribbon cable exit slot.

6. The vehicle steer-by-wire system of claim 2, wherein the guide tube comprises a straight segment and a curved segment, wherein the straight segment and is tubular to define a guide tube interior, wherein the curved segment is a curved flange segment having a flat edge.

7. The vehicle steer-by-wire system of claim 6, wherein the flat ribbon cable has a first portion disposed in contact with the flat edge of the curved flange segment, wherein the flat ribbon cable enters a first open end of the straight segment of the guide tube and extends along the guide tube interior with a second portion of the flat ribbon cable.

8. The vehicle steer-by-wire system of claim 7, wherein the straight segment defines a ribbon cable exit slot, wherein the flat ribbon cable extends through the ribbon cable exit slot, wherein a third portion of the flat ribbon cable wraps along an outer diameter of the straight segment.

9. The vehicle steer-by-wire system of claim 1, wherein the electrical connection conduit is a twisted bundle of wires, wherein the guide tube comprises a straight segment and a curved segment, wherein the straight segment and the curved segment are both tubular to define a guide tube interior.

10. The vehicle steer-by-wire system of claim 9, wherein the twisted bundle of wires extends through the guide tube and protrudes from a first open end of the guide tube and from a second open end of the guide tube.

11. The vehicle steer-by-wire system of claim 1, wherein the guide tube extends through a first bushing and through a second bushing.

12. The vehicle steer-by-wire system of claim 11, wherein the first bushing is located within a first end of the spindle and the second bushing is located within a second end of the spindle, wherein the first end of the spindle is located further from the column jacket, relative to a distance between the second end of the spindle and the column jacket.

13. The vehicle steer-by-wire system of claim 11, wherein at least one of the first and second bushings defines a recessed portion along an outer diameter of thereof.

14. The vehicle steer-by-wire system of claim 1, wherein the hand wheel actuator is in operative communication with a road wheel actuator.

15. A vehicle steer-by-wire system comprising:
a column jacket;
a hand wheel actuator operatively coupled to an end of the column jacket, the hand wheel actuator comprising a motor and a spindle, the spindle operatively coupleable to a steering wheel hub; and
a rotatable wire harness assembly comprising:
a guide tube having at least a portion thereof disposed within an interior cavity defined by the spindle, wherein the guide tube comprises a straight segment and a curved segment, wherein the straight segment and the curved segment are both tubular to define a guide tube interior;
a flat ribbon cable having at least a portion thereof disposed within an interior of the guide tube;
a first bushing; and
a second bushing, wherein the guide tube extends through the first bushing and the second bushing.

16. The vehicle steer-by-wire system of claim 15, wherein the straight portion of the guide tube extends through the first bushing and the second bushing.

17. The vehicle steer-by-wire system of claim 15, wherein the flat ribbon cable is positioned within the guide tube interior through the curved segment and is wrapped along an outer diameter of the straight segment.

18. The vehicle steer-by-wire system of claim 17, wherein the straight segment defines a ribbon cable exit slot, wherein the flat ribbon cable extends through the ribbon cable exit slot.

19. A vehicle steer-by-wire system comprising:
a column jacket;
a hand wheel actuator operatively coupled to an end of the column jacket, the hand wheel actuator comprising a motor and a spindle, the spindle operatively coupleable to a steering wheel hub; and
a rotatable wire harness assembly comprising:
a guide tube having at least a portion thereof disposed within an interior cavity defined by the spindle, comprises a straight segment and a curved segment, wherein the straight segment and is tubular to define a guide tube interior, wherein the curved segment is a curved flange segment having a flat edge;
a flat ribbon cable having at least a portion thereof disposed within an interior of the guide tube, wherein the flat ribbon cable has a first portion disposed in contact with the flat edge of the curved flange segment, wherein the flat ribbon cable enters a first open end of the straight segment of the guide tube and extends along the guide tube interior with a second portion of the flat ribbon cable;
a first bushing; and
a second bushing, wherein the guide tube extends through the first bushing and the second bushing.

20. A vehicle steer-by-wire system comprising:
a column jacket;
a hand wheel actuator operatively coupled to an end of the column jacket, the hand wheel actuator comprising a motor and a spindle, the spindle operatively coupleable to a steering wheel hub; and
a rotatable wire harness assembly comprising:
a guide tube having at least a portion thereof disposed within an interior cavity defined by the spindle, wherein the guide tube comprises a straight segment and a curved segment, wherein the straight segment and the curved segment are both tubular to define a guide tube interior;
a twisted bundle of wires extending through the guide tube interior;
a first bushing; and
a second bushing, wherein the guide tube extends through the first bushing and the second bushing.
